(19) United States
(12) Patent Application Publication
(10) Pub. No.: US 2015/0169704 A1
(43) Pub. Date: Jun. 18, 2015

(54) REVERSIBLE USER INTERFACE

(71) Applicant: Google Inc., Mountain View, CA (US)

(72) Inventors: Zoltan Stekkelpak, Sunnyvale, CA (US); Anis Elias Abboud, Shefar am (IL)

(21) Appl. No.: 13/928,540

(22) Filed: Jun. 27, 2013

(51) Int. Cl. G06F 17/30

(52) U.S. Cl. CPC G06F 17/30554

(57) ABSTRACT

A user interface that includes a “reversible” portion may provide additional information related to that portion without causing a user to navigate away from the user interface page.

### TECHNICAL FIELD

This specification generally relates to user interfaces.

### BACKGROUND

Search systems may generate responses to queries by providing search results on user interfaces. These search results may include resources such as web pages, images, video, email, files, or applications, which may be obtained from a remote server and/or from a user's client device. Some search systems may even act in a proactive or predictive manner, providing search results to users without prompting the user to enter a search query. In some cases, the user interfaces may also include portions with factual details responsive to the queries.

### SUMMARY

A search results page user interface that includes a “reversible” portion may provide additional information related to that portion without causing a user to navigate away from the current search results page. In some implementations, a first representation of the reversible portion, e.g., a front side of a panel, may provide factual details while a second representation of that portion, e.g., a reverse side of the panel, provides various additional elements such as curation tools, editing tools, and further information. These additional elements may be aligned with elements from the first representation so that users may readily determine what the additional elements relate to. Alternatively or in addition to factual details, the reversible portion may include resources such as web pages, images, video, email, files, or applications, which may be obtained from a remote server and/or from a user's client device.

In general, one aspect of the subject matter includes the actions of outputting a search results page, the search results page including a portion having one or more elements in a first arrangement, the one or more elements comprising one or more of text elements, image elements, input elements, and video elements. The actions include receiving a command to render a reversed representation of the portion of the search results page. The actions also include generating the reversed representation of the portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements comprising text elements, image elements, input elements, or video elements, and wherein each additional element is associated with the respective element with which the respective additional element is aligned. And the actions include outputting the reversed representation of the portion of the search results page.

In some implementations, the reversed representation comprises one or more additional elements overlaid on or adjacent to at least one of the one or more elements.

Some implementations involve outputting an animated transition between a display showing the portion of the search results page having the one or more elements in the first arrangement and another display showing the reversed representation of the portion of the search results page. The animated transition may include outputting a horizontal rotation animation that transitions between the display showing the portion of the search results page having the one or more elements in the first arrangement and the other display showing the reversed representation of the portion of the search results page.

In some implementations, the reversed representation of the portion of the search results page may include at least one of the one or more elements in the second arrangement being a mirror image of the respective element in the first arrangement. In some implementations, the reversed representation may involve at least one of the one or more elements in the second arrangement being a blurred version of the respective element in the first arrangement.

In some implementations that include a portion having an image element in a first arrangement, the reversed representation may include one or more of a histogram element, a metadata information element, or a feedback input element aligned with the image element. In some implementations that include a portion having an advertisement portion with one or more elements in a first arrangement, the reversed representation may include one or more additional elements aligned with at least one of the one or more elements of the advertisement portion, the one or more additional elements enabling a user to purchase a product or service associated with the advertisement portion.

Implementations described in this specification may realize one or more of the following advantages. Some implementations may allow a user to interact with a portion of a search results page to obtain additional information without leaving the search results page. Some implementations may allow user interface designers to keep a user interface clean by putting only the essential controls on the original portion of the user interface and providing additional elements on the virtual reverse side of the user interface.

The details of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B illustrate an example user interface with a reversible portion.

FIGS. 2A and 2B illustrate another example user interface with a reversible portion.

FIGS. 3A and 3B illustrate still another example user interface with a reversible portion.

FIG. 4 is a flow chart of an example process for providing a user interface with a reversible portion.

Like reference numbers and designations in the various drawings indicate like elements.

### DETAILED DESCRIPTION

A user interface such as a search results page may become crowded with user interface elements, including editing options and help links. In some cases, additional elements may also distract users from completing desired tasks. In a sequence of desired tasks, for example, the success rate of inducing users to complete the entire sequence may decrease as additional steps are added. In one example, if the desired sequence involves asking a user to contribute to factual information, directing the user to a different application or website may decrease the potential contributor's willingness to complete the sequences and/or distract the potential contributor from the desired sequence.

A graphical user interface that allows users to easily access additional elements by reversing a portion of the user interface, e.g., flipping a panel on the user interface to a reverse side, may address some of these limitations. Such an interface may provide a virtual means for users to view “under the hood” elements of the user interface. For example, the reversible portion of the user interface may include resources such as factual descriptions, web pages, images, video, email, files, and/or applications, which may be obtained from a remote server and/or from a user's client device.

A reversible portion of the user interface may be a panel or other segment of a user interface that a user can manipulate to show two or more different representations of the portion. For example, a panel on a web page may mimic a physical panel having a front side and a reverse side such that a user can transition back and forth to access additional information without having to leave the web page. The reverse side of the panel may include the same elements as the front side of the panel in a mirror image arrangement. Some of the elements on the reverse side may also be mirrored or blurred in relation to the elements from the front side, e.g., an image from the front side could be flipped and/or rendered with blurring applied. In addition, the reverse side may include additional elements that are aligned with the elements from the front side (in the mirror image arrangement) to provide additional functionality.

The reversible portion may include various curation tools, editing tools, and additional information that are associated with elements on the front side. An element may refer to components of a user interface such as, for example, text, images, inputs, controls, videos, audio, or any combination of these. In some implementations, an element may correspond to a hypertext markup language (HTML) element. Elements may be arranged and rearranged on a user interface in any suitable manner; for example, elements may be configured in an HTML document using HTML, cascading style sheets (CSS), JavaScript, any combination of these, or any other similar technology.

For example, elements on the reverse side of the portion associated with a text element may include an input field allowing the user to provide feedback, offer editing suggestions, fill out a questionnaire, or change settings for the text. The reverse side may also display additional information and/or options related to the text such as citations, sources, contributors, editors, information about similar topics, rich media (e.g., images, videos, audio), change history, discussion forums (e.g., live chat, video chat, or message forums), help topics, and/or terms and conditions. Examples of elements on the reverse side that may be associated with a media element, e.g., images or video, may include a histogram and metadata such as source, contributor, file size, dimensions, image format, geotags, creation date, and/or change history. In addition, the reverse side could include information such as similar items, endorsements, reviews/ratings, social media activity, recommendations, and/or report abuse features. For an email, elements on the reverse side could include encoding of the email, routing information and source information. For a file icon, the reverse side could include file information such as size, file type, creation date, modification date, and/or file path. For a specific process with an indication displayed on the front side, the reverse side may show actual processes running or a command line representation listing processes.

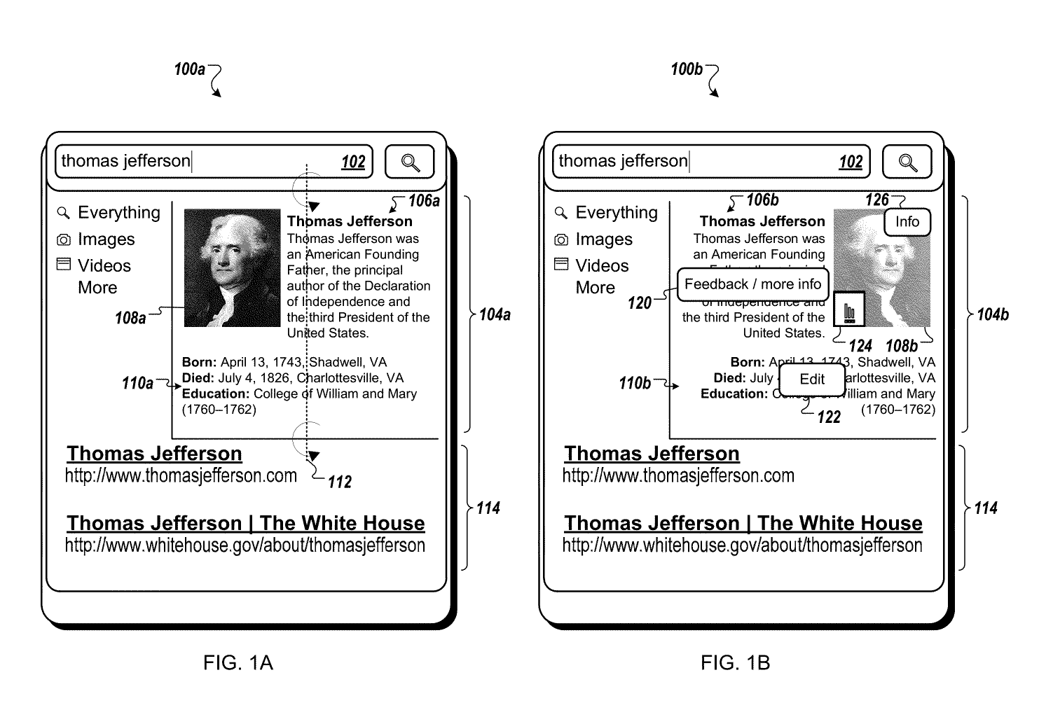

FIGS. 1A and 1B illustrate an example user interface with a reversible portion. The user interface may be displayed in response to a user inputting a search query at a client device. The client device may include one or more processing devices, and may be, or include, a mobile telephone (e.g., a smartphone), a laptop computer, a desktop computer, a handheld computer, a tablet computer, a network appliance, a camera, an enhanced general packet radio service (EGPRS) mobile phone, a media player, a navigation device, an email device, a game console, an interactive or so-called “smart” television, a smart watch, a head mounted display device, or a combination of any two or more of these data processing devices or other data processing devices.

Initially, a user enters a query into the search box 102 at their client device, e.g., “Thomas Jefferson.” The client device submits the query to a search engine and the search engine then responds with search results. Upon receiving the search results, the client device renders the search results page 100a shown in FIG. 1A. The search results page 100a may include a portion 104a with factual information responsive to the query as well as links to various documents 114 that are responsive to the query.

In some implementations, the search engine may provide search results to the client device based on predictions (e.g., using machine learning and/or similar users' behavior) without a user explicitly submitting a search query. For example, assume that a user's email account includes a flight confirmation email for a departure flight. Three hours before the scheduled departure, the user may access the search engine (e.g., an application or website), and the search engine may provide the current status of the flight (e.g., on time, delayed) without the user entering a search query. This result could be based on a high confidence prediction of the user's potential behavior.

The portion 104a may be the front side of a reversible panel that allows the user to transition the panel between the front side as shown in FIG. 1A and a reverse side as shown in FIG. 1B. The front side of the panel 104a includes factual information that is responsive to the “Thomas Jefferson” query. In particular, the front side 104a includes a first text element 106a describing Thomas Jefferson, an image 108a of Thomas Jefferson, and another text element 110a that includes further information about Thomas Jefferson.

The user may trigger a transition of the panel from the front side 104a to the reverse side 104b, for example, by a mouseover, a single click, a double click, a gesture (e.g., a touch gesture, a body movement gesture such as head or arm, or an eye gesture such as gaze tracking), a voice action (e.g., “show me more,” “give me details,” or “flip this”), a control element (not shown), or any combination of these. In client devices that include an accelerometer and/or gyroscope, the transition could be triggered by the user initiating a physical flipping motion with the client device. Alternatively or in addition, the transition could be triggered to flip to the reverse side 104b without any prompt or action from the user. For example, the transition could be based on a timer—if the front side 104b is visible for more than a predetermined amount of time (e.g., N seconds or N minutes), the transition would be triggered.

Upon receiving the user's command to trigger the transition, the client device generates and renders the reverse side of the panel 104b, optionally presenting an animated transition between the front side 104a and the reverse side 104b. For example, when the transition is triggered, the panel may be animated to appear to rotate about a vertical axis 112. Alternatively or in addition, other transition effects may be used, such as, for example, rotation about a horizontal axis, rotation about a diagonal axis, a folding animation, or any other suitable animation. In some implementations, the transition may simply replace the front side of the panel 104a on the search results page 100a with the reverse side of the panel 104b with no animation.

While only a single panel is shown in FIG. 1A, some implementations may involve multiple reversible panels. In such implementations, each of the panels may be independently triggered to transition from the front side to the reverse side. Alternatively or in addition, a subset of the panels may be related such that triggering one of the panels causes all of the panels in the subset to transition from the front side to the reverse side.

The reverse side of the panel 104b includes the elements from the front side of the panel 104a in a mirror image arrangement around the vertical axis 112. For example, the position of the elements on the front side of the panel 104a may be mirrored on the reverse side of the panel 104b to create the appearance that a user is viewing the flip side of the panel 104a. In particular, whereas the original image 108a is in a top left position on the front side of the panel 104a, the corresponding image 108b is in a top right position on the reverse side of the panel 104b. Also, the original text 106a is in a top right position on the front side of the panel 104a, while the corresponding text 106b in a top left position on the reverse side of the panel 104b. And the original text 110a is in a bottom left position on the front side of the panel 104a, while the corresponding text 110b in a bottom right position on the reverse side of the panel 104b.

The elements on the reverse side of the panel 104a may also be mirrored and/or modified. For example, in some implementations, images may be mirrored and/or blurred on the reverse side of the panel 104b. As shown in FIG. 1B, the image 108a from the front side of the panel 104a has been flipped horizontally and blurred to form a corresponding image 108b. In some implementations, text is not mirrored or blurred on the reverse side of the panel 104b as these effects could make the text difficult to read, but text may be changed from left justified on the front side of the panel 104a to right justified on the reverse side of the panel 104b. Alternatively or in addition, in some implementations the text may be mirrored and/or blurred on the reverse side of the panel 104b. Additionally, some implementations may enable a user to selectively unblur and/or unmirror elements on the reverse side of the panel 104b to facilitate editing. For example, if text is blurred and mirrored, the user may unblur and unmirror the text for editing by way of a mouseover, a single click, a double click, a touch gesture, a control element (not shown), or any combination of these.

In addition to the mirrored original elements 106b, 108b, 110b from the front side of the panel 104a, the reverse side of the panel 104b includes additional elements 120, 122, 124, 126 that are aligned with the mirrored elements. Advantageously, the alignment of the additional elements 120, 122, 124, 126 with the mirrored elements 106b, 108b, 110b creates a visual association between the additional elements and the mirrored elements so as to provide users with guidance about the function of the additional elements. This visual association may help users determine the function of the additional elements without excessively cluttering the user interface. While shown in FIG. 1B as overlaying the mirrored elements, the additional elements 120, 122, 124, 126 could also be aligned to be adjacent to (e.g., above, below, or beside) the mirrored elements 106b, 108b, 110b.

The additional elements may provide additional functionality such as curation tools, editing tools, and/or additional information. For example, the “Feedback/more info” control element 120 may allow a user to provide comments or obtain additional information about the text in the text element 106b. In particular, when the user selects the control element 120, the user interface may display an input field allowing the user to provide feedback, offer editing suggestions, fill out a questionnaire, or change settings for the text. In addition, the user interface may display a dialog box with additional information and/or options related to the text such as citations, sources, contributors, editors, information about similar topics, rich media (e.g., images, videos, audio), change history, discussion forums (e.g., live chat, video chat, or message forums), help topics, and/or terms and conditions. Similarly, the “Edit” control element 122 may allow a user to provide comments on the text in the text element 110b. For example, when the user selects the control element 122, the user interface may display an input field allowing the user to offer editing suggestions for the text. The histogram element 124 may provide a graphical representation of the tonal distribution in the image 108b. The “Info” control element 126 may provide additional information about the image 108b, such as, for example, source, contributor, file size, dimensions, image format, geotags, creation date, etc.

In some implementations, various elements of the user interface may be modified when the user interface transitions the portion to the reverse side. For example, some elements outside of the reversible portion could be blurred or greyed out to focus attention on the reverse side. On some devices, as an additional effect, a mouse pointer could become mirrored when the pointer is hovering over the reverse side. In implementations where the front side of the panel produces a sound effect in stereo, the right and left audio channels could be reversed when the panel is reversed. In an example scenario, assume that a user is watching a video that is displayed in the reversible portion of a web page. The user may reverse the panel to view additional information about the video while watching the video, and as a result, the audio channels could be reversed.

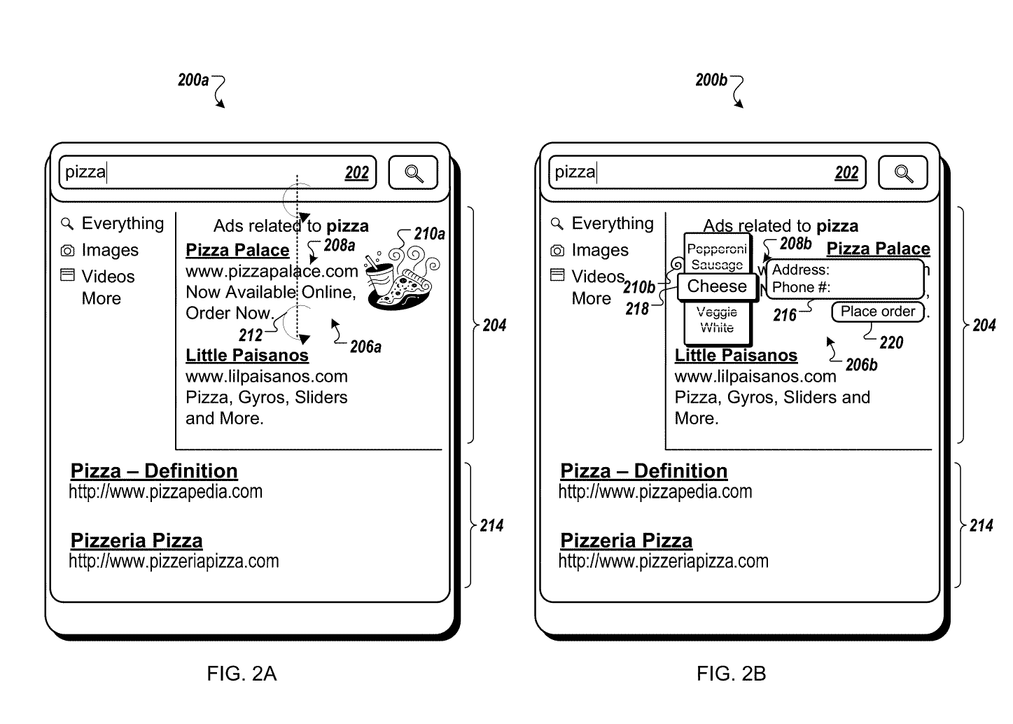

FIGS. 2A and 2B illustrate another example user interface with a reversible portion. The user interface may be displayed in response to a user inputting a search query at a client device. Initially, a user enters a query into the search box 202 at their client device, e.g., “pizza.” The client device submits the query to a search engine and the search engine then responds with search results. Upon receiving the search results, the client device renders the search results page 200a shown in FIG. 2A. The search results page 200a may include a portion 204 with advertisements related to the query as well as links to various documents 214 that are responsive to the query.

As shown in FIG. 2A, one of the advertisements 206a (e.g., an advertisement for Pizza Palace) represents the front side of a reversible panel, which allows the user to transition the panel between the front side as shown in FIG. 2A and a reverse side as shown in FIG. 2B. The front side of the panel 206a includes a text element 208a for the advertisement and an image 210a for the advertisement.

The user may trigger a transition of the panel from the front side 206a to the reverse side 206b, for example, by a mouseover, a single click, a double click, a touch gesture, a control element (not shown), or any combination of these. In client devices that include an accelerometer and/or gyroscope, the transition could be triggered by the user initiating a physical flipping motion with the client device. Upon receiving the user's command to trigger the transition, the client device generates and renders the reverse side of the panel 206b, optionally presenting an animated transition between the front side 206a and the reverse side 206b. For example, when the transition is triggered, the panel may be animated to appear to rotate about a vertical axis 212. Alternatively or in addition, other transition effects may be used, such as, for example, rotation about a horizontal axis, rotation about a diagonal axis, a folding animation, or any other suitable animation. In some implementations, the transition may simply replace the front side of the panel 206a on the search results page 200a with the reverse side of the panel 206b with no animation.

While only a single panel for one advertisement is shown in FIG. 2A, some implementations may involve multiple reversible panels for multiple advertisements. In such implementations, each of the panels may be independently triggered to transition from the front side to the reverse side. Alternatively or in addition, a subset of the panels may be related such that triggering one of the panels causes all of the panels in the subset to transition from the front side to the reverse side.

The reverse side of the panel 206b includes the elements from the front side of the panel 206a in a mirror image arrangement around the vertical axis 212. Whereas the original text 208a is in a leftmost position on the front side of the panel 206a, the corresponding text 208b in a rightmost position on the reverse side of the panel 206b. Also, while the original image 210a is in rightmost position on the front side of the panel 206a, the corresponding image 210b is in a leftmost position on the reverse side of the panel 206b.

The elements on the reverse side of the panel 206a may also be mirrored and/or modified. For example, in some implementations, images may be mirrored and/or blurred on the reverse side of the panel 206b. In some implementations, text is not mirrored or blurred on the reverse side of the panel 206b as these effects could make the text difficult to read, but text may be changed from left justified on the front side of the panel 206a to right justified on the reverse side of the panel 206b. Alternatively or in addition, in some implementations the text may be mirrored and/or blurred on the reverse side of the panel 206b.

In addition to the mirrored original elements 208b, 210b from the front side of the panel 206a, the reverse side of the panel 206b includes additional elements 216, 218, 220 that are aligned with the mirrored elements. Advantageously, the alignment of the additional elements 216, 218, 220 with the mirrored elements 208b, 210b creates a visual association between the additional elements and the mirrored elements so as to provide users with guidance about the function of the additional elements. This visual association may help users determine the function of the additional elements without excessively cluttering the user interface. While shown in FIG. 2B as overlaying the mirrored elements, the additional elements 216, 218, 220 could also be aligned to be adjacent to (e.g., above, below, or beside) the mirrored elements 208b, 210b.

The additional elements may provide an order form that allows a user to purchase the products advertised on the front side of the panel 208a without leaving the search results page 200a. For example, the input box 216 may allow the user to enter and/or verify their delivery information (e.g., address and phone number), the selection element 218 may allow a user to select one or more types of pizza (e.g., pepperoni, sausage, cheese, veggie, or white), and the button 220 may allow the user place their order. In particular, when the user selects the “place order” button 220, the user interface display a dialog box confirming the user's order and/or requesting additional information such as payment information.

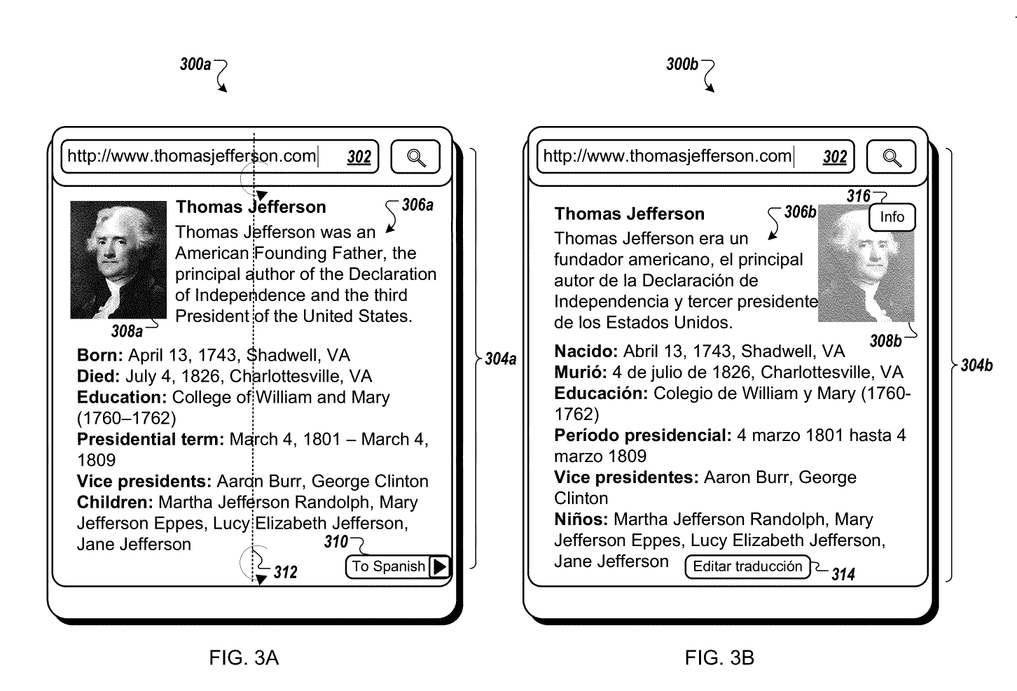

FIGS. 3A and 3B illustrate still another example user interface 300 with a reversible portion. The user interface may be displayed in response to a user accessing a web page. For example, a user may navigate to a URL by entering the URL into a search/address bar 302, e.g., “http://www.thomasjefferson.com,” using a web browser. The browser and/or search engine that directs the browser to the URL may determine that the user may be interested in viewing a translation of the web page into another language. For example, the browser and/or search engine may determine that the browser request originates from a Spanish-speaking country (e.g., Mexico), while the language of the web page is in another language (e.g., English). In response to making this determination, the browser renders the web page in a reversible panel.

The front side of a reversible panel 304a allows the user to transition the panel between the front side as shown in FIG. 3A and a reverse side as shown in FIG. 3B. The front side of the panel 304a includes the original web page at the “http://www.thomasjefferson.com” URL. In particular, the front side 304a includes a first text element 306a describing Thomas Jefferson and an image 308a of Thomas Jefferson. Also, based on the determination that the user may be interested in viewing a translation of the web page, the panel 304a also includes a control button 310 that allows the user to trigger a transition to a translated version of the web page.

The user may trigger a transition of the panel from the front side 304a to the reverse side 304b, for example, using the control button 310, a mouseover, a single click, a double click, a touch gesture, or any combination of these. In client devices that include an accelerometer and/or gyroscope, the transition could be triggered by the user initiating a physical flipping motion with the client device. Upon receiving the user's command to trigger the transition, the client device generates and renders the reverse side of the panel 304b, optionally presenting an animated transition between the front side 304a and the reverse side 304b. For example, when the transition is triggered, the panel may be animated to appear to rotate about a vertical axis 312. Alternatively or in addition, other transition effects may be used, such as, for example, rotation about a horizontal axis, rotation about a diagonal axis, a folding animation, or any other suitable animation. In some implementations, the transition may simply replace the front side of the panel 304a on the web page 300a with the reverse side of the panel 304b with no animation.

The reverse side of the panel 304b includes the elements from the front side of the panel 304a in a mirror image arrangement around the vertical axis 312. For example, the position of the elements on the front side of the panel 304a may be mirrored on the reverse side of the panel 304b to create the appearance that a user is viewing the flip side of the panel 304a. In particular, whereas the original image 308a is in a top left position on the front side of the panel 304a, the corresponding image 308b is in a top right position on the reverse side of the panel 304b. Also, the original text 306a is in a top right position on the front side of the panel 304a, while the corresponding text 306b in a top left position on the reverse side of the panel 304b.

The elements on the reverse side of the panel 304a may also be mirrored and/or modified. For example, in some implementations, images may be mirrored and/or blurred on the reverse side of the panel 304b. As shown in FIG. 3B, the image 308a from the front side of the panel 304a has been flipped horizontally and blurred to form a corresponding image 308b. In some implementations, text is not mirrored or blurred on the reverse side of the panel 304b as these effects could make the text difficult to read, but text may be changed from left justified on the front side of the panel 304a to right justified on the reverse side of the panel 304b.

In addition to the mirrored original elements 306b, 308b from the front side of the panel 304a, the reverse side of the panel 304b includes additional elements 314, 316 that are aligned with the mirrored elements. As shown in FIG. 3B the additional elements 314, 316 may be aligned to be overlaid upon or adjacent to (e.g., above, below, or beside) the mirrored elements 306b, 308b.

The additional elements may provide additional functionality such as curation tools, editing tools, and/or additional information. Similarly, the “Editar traducción” control element 314 may allow a user to provide comments on the translation of the text in the text element 306b. The “Info” control element 316 may provide additional information about the image 308b, such as, for example, source, contributor, file size, dimensions, image format, geotags, creation date, etc.

In some implementations, input elements associated with the front side of the panel 304a may change functions when the user transitions to the reverse side the panel 304b. For example, the function of the search/address bar 302 may change when the user transitions to the reverse side of the panel 304b. The search/address bar 302 could be animated to appear to rotate simultaneously with the web page. Then, while the user is viewing the reverse side of the panel 304b, the input method of the search/address bar 302 could be changed from English to Spanish. This may be particularly useful in cases where the language of the original web page and the language of the translation are based on different character sets (e.g., English and Hebrew, English and Russian, English and Japanese, etc.).

Various additional functions may be implemented for the reverse side of a full web page other than translations of the web page. For example, the reverse side may provide summarized texts of the web page. In some implementations, the reverse side could provide tools for debugging the output of the web page or the browser rendering the web page. The reverse side could also provide source code for the web page (e.g., HTML, CSS, and/or JavaScript).

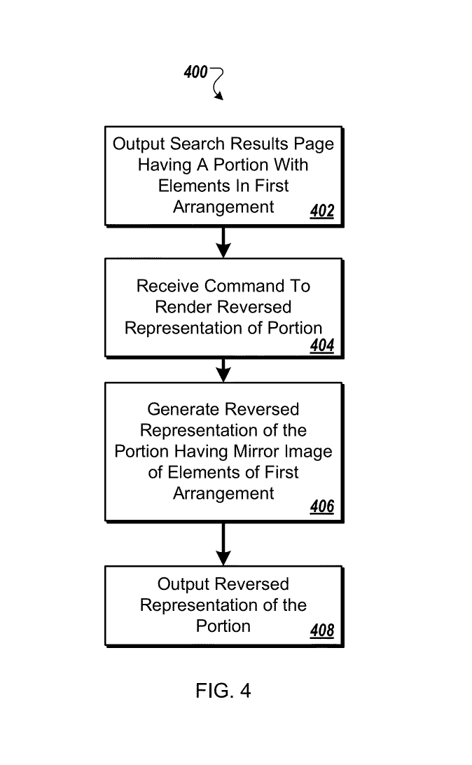

FIG. 4 shows an example process 400 for providing a user interface with a reversible portion. The process 400 will be described as being performed by a client device such as a mobile telephone (e.g., a smartphone), a laptop computer, a desktop computer, a handheld computer, a tablet computer, a network appliance, a camera, an enhanced general packet radio service (EGPRS) mobile phone, a media player, a navigation device, an email device, a game console, an interactive or so-called “smart” television, a smart watch, a head mounted display device, or a combination of any two or more of these data processing devices or other data processing devices. While the steps are illustrated in a particular sequence in FIG. 4, the steps may be implemented in any suitable sequence.

Initially, in step 402, the client device outputs a search results page. For example, a user may submit a search query to a search engine using a browser on the client device, and the search engine may provide the search results page in response. Alternatively or in addition, the search engine may provide search results to the client device based on predictions (e.g., using machine learning and/or similar users' behavior) without a user explicitly submitting a search query.

The search results page includes a portion (e.g., a front side of a panel) having one or more elements in a first arrangement, where the one or more elements may include text elements, image elements, input elements, and video elements. In some implementation, the portion may include an advertisement portion having one or more elements in a first arrangement. In some implementations, the search results page may include factual information along with links and/or snippets of various web pages. In some implementations, the search results page may include only factual information without providing links and/or snippets of other web pages.

Next, in step 404, the client device receives a command to render a reversed representation of the portion of the search results page (e.g., a reverse side of the panel). The command may be, for example, from a mouseover, a single click, a double click, a gesture (e.g., a touch gesture, a body movement gesture such as head or arm, or an eye gesture such as gaze tracking), a voice action (e.g., “show me more,” “give me details,” or “flip this”), a control element, or any combination of these. In client devices that include an accelerometer and/or gyroscope, the command could be a user initiating a physical flipping motion with the client device. Alternatively or in addition, the command could be generated by the client device without any prompt or action from the user. For example, the command could be based on a timer—if the front side of the panel is visible for more than a predetermined amount of time (e.g., N seconds or N minutes), a transition would be triggered.

The client device then generates the reversed representation of the portion of the search results page in step 406. The reversed representation includes the one or more elements in a second arrangement that is a mirror image of the first arrangement. The reversed representation includes one or more additional elements aligned with the one or more elements from the front side of the panel, where the one or more additional elements may include text elements, image elements, input elements, or video elements. Each additional element is associated with the respective element with which the respective additional element is aligned. The additional elements may be adjacent to (e.g., above, below, or beside) or overlaid on their associated elements. Some implementations may involve one or more of the elements in the reversed representation being mirrored and/or blurred versions of the respective elements in the original portion of the web page. In implementations that include an advertisement portion on the search results page, the reversed representation may include one or more additional elements that enable a user to purchase a product or service associated with the advertisement portion without leaving the search results page.

The additional elements in the reversed representation (e.g., the reverse side of a panel) may provide various functions to the user related to the respective element the additional element is aligned with. For example, elements on the reverse side associated with a text element may include an input field allowing the user to provide feedback, offer editing suggestions, fill out a questionnaire, or change settings for the text. The reverse side may also display additional information and/or options related to the text such as citations, sources, contributors, editors, information about similar topics, rich media (e.g., images, videos, audio), change history, discussion forums (e.g., live chat, video chat, or message forums), help topics, and/or terms and conditions. Examples of elements on the reverse side that may be associated with a media element, e.g., images or video, may include a histogram and metadata such as source, contributor, file size, dimensions, image format, geotags, creation date, and/or change history. In addition, the reverse side could include information such as similar items, endorsements, reviews/ratings, social media activity, recommendations, and/or report abuse features. For an email, elements on the reverse side could include encoding of the email, routing information and source information. For a file icon, the reverse side could include file information such as size, file type, creation date, modification date, and/or file path. For a specific process with an indication displayed on the front side, the reverse side may show actual processes running or a command line representation listing processes.

Finally, in step 408, the client device outputs the reversed representation of the portion of the search results page. Some implementations may involve an animated transition between a display showing the portion of the search results page having the one or more elements in the first arrangement and another display showing the reversed representation of the portion of the search results page. The animated transition may be, for example, rotation about a horizontal axis, rotation about a diagonal axis, a folding animation, or any other suitable animation.

While certain example implementations have been described above with relation to process 400, various alternatives are within the scope of the present specification. For example, while only a single panel is described in relation to process 400, some implementations may involve multiple reversible panels. In such implementations, each of the panels may be independently triggered to transition from the front side to the reverse side. Alternatively or in addition, a subset of the panels may be related such that triggering one of the panels causes all of the panels in the subset to transition from the front side to the reverse side.

In addition, while described above as being implemented on a search results page, some implementations may involve other types of user interfaces such as other types of web pages or mobile applications. A general implementation may involve a client device that outputs a representation of a first user interface, where the representation of the first user interface includes one or more original elements in a first arrangement. The original elements may include text elements, image elements, and video elements. The client device then receives a command to render a representation of a second user interface. In response, the client device outputs a representation of a second user interface, where the representation of the second user interface includes the original elements in a second arrangement that is a mirror image of the first arrangement. The second user interface also includes one or more additional elements aligned with at least one of the original elements, where each additional element is associated with the respective element with which the respective additional element is aligned.

Additionally, while described above as having a front side and a reverse side, the reversible portion of the web page as described herein need not be limited to a two-sided object. Some implementations may include a reversible portion represented by a three-dimensional object having multiple sides (e.g., a tetrahedron, cube, or other polyhedron).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a processing system on data stored on one or more computer-readable storage devices or received from other sources.

The term “processing system” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
outputting a search results page, the search results page including a portion having one or more elements in a first arrangement, the one or more elements comprising one or more of text elements, image elements, input elements, and video elements;
receiving a command to render a reversed representation of the portion of the search results page;
generating the reversed representation of the portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements comprising text elements, image elements, input elements, or video elements, and wherein each additional element is associated with the respective element with which the respective additional element is aligned; and
outputting the reversed representation of the portion of the search results page.

2. The method of claim 1, wherein the reversed representation comprises one or more additional elements overlaid on at least one of the one or more elements.

3. The method of claim 1, wherein outputting the reversed representation of the portion of the search results page comprises outputting an animated transition between a display showing the portion of the search results page having the one or more elements in the first arrangement and another display showing the reversed representation of the portion of the search results page.

4. The method of claim 3, wherein outputting an animated transition between a display showing the portion of the search results page having the one or more elements in the first arrangement and another display showing the reversed representation of the portion of the search results page comprises outputting a horizontal rotation animation that transitions between the display showing the portion of the search results page having the one or more elements in the first arrangement and the other display showing the reversed representation of the portion of the search results page.

5. The method of claim 1, wherein generating the reversed representation of the portion of the search results page, the reversed representation including the one or more elements in a second arrangement, the second arrangement being a mirror image of the first arrangement comprises generating the reversed representation of the portion of the search results page, the reversed representation including the one or more elements in a second arrangement, the second arrangement being a mirror image of the first arrangement, and wherein at least one of the one or more elements in the second arrangement is a mirror image of the respective element in the first arrangement.

6. The method of claim 1, wherein generating the reversed representation of the portion of the search results page, the reversed representation including the one or more elements in a second arrangement, the second arrangement being a mirror image of the first arrangement comprises generating the reversed representation of the portion of the search results page, the reversed representation including the one or more elements in a second arrangement, the second arrangement being a mirror image of the first arrangement, and wherein at least one of the one or more elements in the second arrangement is a blurred version of the respective element in the first arrangement.

7. The method of claim 1,
wherein outputting a search results page, the search results page including a portion having one or more elements in a first arrangement, the one or more elements comprising one or more of text elements, image elements, input elements, and video elements comprises outputting a search results page, the search results page including a portion having an image element in a first arrangement; and
wherein generating the reversed representation of the portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements comprising text elements, image elements, input elements, or video elements, and wherein each additional element is associated with the respective element with which the respective additional element is aligned comprises generating the reversed representation of the portion of the search results page, the reversed representation including the image element in a second arrangement, the second arrangement being a mirror image of the first arrangement, wherein the reversed representation comprises one or more of a histogram element, a metadata information element, or a feedback input element aligned with the image element.

8. The method of claim 1,
wherein outputting a search results page, the search results page including a portion having one or more elements in a first arrangement, the one or more elements comprising one or more of text elements, image elements, input elements, and video elements comprises outputting a search results page, the search results page including an advertisement portion having one or more elements in a first arrangement; and
wherein generating the reversed representation of the portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements comprising text elements, image elements, input elements, or video elements, and wherein each additional element is associated with the respective element with which the respective additional element is aligned comprises generating the reversed representation of the advertisement portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements enabling a user to purchase a product or service associated with the advertisement portion.

9. A system comprising:
one or more computers and one or more storage devices storing instructions that are operable, when executed by the one or more computers, to cause the one or more computers to perform operations comprising:
outputting a search results page, the search results page including a portion having one or more elements in a first arrangement, the one or more elements comprising one or more of text elements, image elements, input elements, and video elements;
receiving a command to render a reversed representation of the portion of the search results page;
generating the reversed representation of the portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements comprising text elements, image elements, input elements, or video elements, and wherein each additional element is associated with the respective element with which the respective additional element is aligned; and
outputting the reversed representation of the portion of the search results page.

10. The system of claim 9, wherein the reversed representation comprises one or more additional elements overlaid on at least one of the one or more elements.

11. The system of claim 9, wherein outputting the reversed representation of the portion of the search results page comprises outputting an animated transition between a display showing the portion of the search results page having the one or more elements in the first arrangement and another display showing the reversed representation of the portion of the search results page.

12. The system of claim 11, wherein outputting an animated transition between a display showing the portion of the search results page having the one or more elements in the first arrangement and another display showing the reversed representation of the portion of the search results page comprises outputting a horizontal rotation animation that transitions between the display showing the portion of the search results page having the one or more elements in the first arrangement and the other display showing the reversed representation of the portion of the search results page.

13. The system of claim 9, wherein generating the reversed representation of the portion of the search results page, the reversed representation including the one or more elements in a second arrangement, the second arrangement being a mirror image of the first arrangement comprises generating the reversed representation of the portion of the search results page, the reversed representation including the one or more elements in a second arrangement, the second arrangement being a mirror image of the first arrangement, and wherein at least one of the one or more elements in the second arrangement is a mirror image of the respective element in the first arrangement.

14. The system of claim 9, wherein generating the reversed representation of the portion of the search results page, the reversed representation including the one or more elements in a second arrangement, the second arrangement being a mirror image of the first arrangement comprises generating the reversed representation of the portion of the search results page, the reversed representation including the one or more elements in a second arrangement, the second arrangement being a mirror image of the first arrangement, and wherein at least one of the one or more elements in the second arrangement is a blurred version of the respective element in the first arrangement.

15. The system of claim 9,
wherein outputting a search results page, the search results page including a portion having one or more elements in a first arrangement, the one or more elements comprising one or more of text elements, image elements, input elements, and video elements comprises outputting a search results page, the search results page including a portion having an image element in a first arrangement; and
wherein generating the reversed representation of the portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements comprising text elements, image elements, input elements, or video elements, and wherein each additional element is associated with the respective element with which the respective additional element is aligned comprises generating the reversed representation of the portion of the search results page, the reversed representation including the image element in a second arrangement, the second arrangement being a mirror image of the first arrangement, wherein the reversed representation comprises one or more of a histogram element, a metadata information element, or a feedback input element aligned with the image element.

16. The system of claim 9,
wherein outputting a search results page, the search results page including a portion having one or more elements in a first arrangement, the one or more elements comprising one or more of text elements, image elements, input elements, and video elements comprises outputting a search results page, the search results page including an advertisement portion having one or more elements in a first arrangement; and
wherein generating the reversed representation of the portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements comprising text elements, image elements, input elements, or video elements, and wherein each additional element is associated with the respective element with which the respective additional element is aligned comprises generating the reversed representation of the advertisement portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements enabling a user to purchase a product or service associated with the advertisement portion.

17. A non-transitory computer-readable medium storing software comprising instructions executable by one or more computers which, upon such execution, cause the one or more computers to perform operations comprising:
outputting a search results page, the search results page including a portion having one or more elements in a first arrangement, the one or more elements comprising one or more of text elements, image elements, input elements, and video elements;
receiving a command to render a reversed representation of the portion of the search results page;
generating the reversed representation of the portion of the search results page, the reversed representation including the one or more elements in a second arrangement, the second arrangement being a mirror image of the first arrangement, wherein the reversed representation comprises one or more additional elements aligned with at least one of the one or more elements, the one or more additional elements comprising text elements, image elements, input elements, or video elements, and wherein each additional element is associated with the respective element with which the respective additional element is aligned; and
outputting the reversed representation of the portion of the search results page.

18. The method of claim 17, wherein the reversed representation comprises one or more additional elements overlaid on at least one of the one or more elements.

19. The method of claim 17, wherein outputting the reversed representation of the portion of the search results page comprises outputting an animated transition between a display showing the portion of the search results page having the one or more elements in the first arrangement and another display showing the reversed representation of the portion of the search results page.

20. The method of claim 19, wherein outputting an animated transition between a display showing the portion of the search results page having the one or more elements in the first arrangement and another display showing the reversed representation of the portion of the search results page comprises outputting a horizontal rotation animation that transitions between the display showing the portion of the search results page having the one or more elements in the first arrangement and the other display showing the reversed representation of the portion of the search results page.
